(19) United States
(12) Patent Application Publication
(10) Pub. No.: US 2008/0315001 A1
(43) Pub. Date: Dec. 25, 2008

(54) Residencial and industrial smooth rail extension

(76) Inventor: David Del Valle, Arecibo, PR (US)

Correspondence Address: David Del Valle, HC 03, Box 20533, Arecibo, PR, 00612, US

(21) Appl. No.: 11/819,110

(22) Filed: Jun. 25, 2007

(51) Int. Cl. E05B 5/02

(52) U.S. Cl. 238/1

(57) ABSTRACT

A rail that requires minimum force to slide an object. It can be assemble by rail pieces until obtaining the desired length.

### BACKGROUND OF THE INVENTION

1. Field of the Invention

This invention is based on a rail that facilitates the movement to the object that will slide. It is also designed to easily add another rail to it. This will allowed a desired rail sizes without complications. To reach an easy sliding we utilize a round based system through where the wheel will slide. This will prevent the friction to be as extreme as on the one in triangular bases without affecting its final function, to slide an object.

2. Description of the Prior Art

Rails have a very important role in the history of transportation and they have been made in many forms and many sizes. They all have the same function. Although some of them are developed for specific functions and because of it they differ from one another. in our case, we created a rail that requires minimum force to slide an object over it and at the same time can be assembled in sections in order to obtain a desire size with a minimum effort. There are many existing rails on the prior art. Typical of these are U.S. Pat. Nos. 607,221, 674,228, 2,209,725, 4,648,554, 6,398,122 B1, 7,152,807 B2, 7,156,723 B2, 7,210,636 B2. Many rails types have been invented each of them differ from the other. This invention differs from the others because of the minimum force required to slide an object. This is obtained thanks to a round rod utilized to where a wheel is slide and, where a rail is added to pre-determined areas in order to obtain the desire size or space.

U.S. Pat. No. 4,648,554

### Inventor: McQueen

### Issued: Mar. 10, 1987

An elastomeric pad, particularly adapted for placement between a prestressed concrete railroad tie and a supported rail, comprises a plurality of dimples formed on opposite sides of the pad in predetermined patterns to attenuate impact and vibrational forces imposed thereon. The centers of the dimples formed on one side of the pad are offset longitudinally and laterally relative to the centers of the dimples formed on the opposite side of the pad to form a network of interlocked arch bridge portions when the pad is viewed in cross-section and such that a majority of dimples on the opposite side underlies and is substantially tangential to four overlying dimples of the one side when the pad is viewed in plan. The pad functions to distribute compressive stresses substantially uniformly throughout and within the elastic limits of the pad when impact loads are imposed thereon.

U.S. Pat. No. 6,398,122 B1

### Inventor: Kowalyk et al.

### Issued: Jun. 4, 2002

A railroad track has a heavier rail section and a lighter rail section. Compromise rails join the heavier and lighter rails. Each compromise rail has a head with a heavier end to match the profile of the heavier rails and a lighter end to match the profile of the lighter rails. Each compromise rail is symmetrical about a straight center line extending from one end to the other. The width of the compromise rail tapers uniformly from the lighter end to the heavier end. This results in a slightly different gauge along the compromise rail section from the standard gauge. The different gauges are accommodated by adjusting the gauge at an end portion of the lighter rail section and at an end portion of the heavier rail section.

U.S. Pat. No. 7,152,807 B2

### Inventor: Nevins

### Issued: Dec. 26, 2006

A rail pad assembly and an associated method for use with a concrete rail tie. The rail pad assembly includes a rail pad for engagement with a metal rail, a protective sheet for engagement with a concrete rail tie, and means for attaching the rail pad to the sheet integrally formed in at least one of the rail pad and the protective sheet. In one specific example, the protective sheet is made from ultrahigh molecular weight polyethylene.

U.S. Pat. No. 7,156,723 B2

### Inventor: Natarajan et al.

### Issued: Jan. 2, 2007

A system for the grinding of unencumbered and encumbered sections of rail includes a locomotive that pulls a first and a second grinding module. The first grinding module is movable between a first and a second position. In the first position, the first grinding module is presented at angle enabling grinding of unencumbered section of rail while in the second position, the first grinding module is presented at an able enabling grinding of the encumbered section of rail. The locomotive continues in non-stop forward motion while the first grinding module is moved back and forth between its first and second positions. The second grinding module is generally used only for grinding of encumbered rail sections and is used simultaneously with the first grinding module in its second position.

U.S. Pat. No. 7,210,636 B2
Inventor: Jäger et al.

### Issued: May 1, 2007

In a transition rail (1) for the connection of rails having different rail cross sections (2, 3), the transition rail (1) comprises two transition zones (a,c), wherein in a first transition zone (c) the larger-height cross-sectional profile is reshaped to transition into a smaller profile height and in the following, second transition zone (a) the rail foot is worked to match the new profile of the consecutive rail foot. The method for producing the transition rail is characterized in that the transition rail is at first heated and introduced into a press mold, whereupon the rail is reshaped in the web region and pressed in the direction of the profile height, and that the rail foot is mechanically worked following complete reshaping.

### BRIEF DESCRIPTION OF THE DRAWING FIGURES

FIG. 1 A complete rail piece

FIG. 2 Two rail pieces to be assembled together

FIG. 3 Two rail pieces about to be completely assembled

FIG. 4 Rail anchored to concrete with its wheel

FIG. 5 Rail screwed to the concrete with its wheel

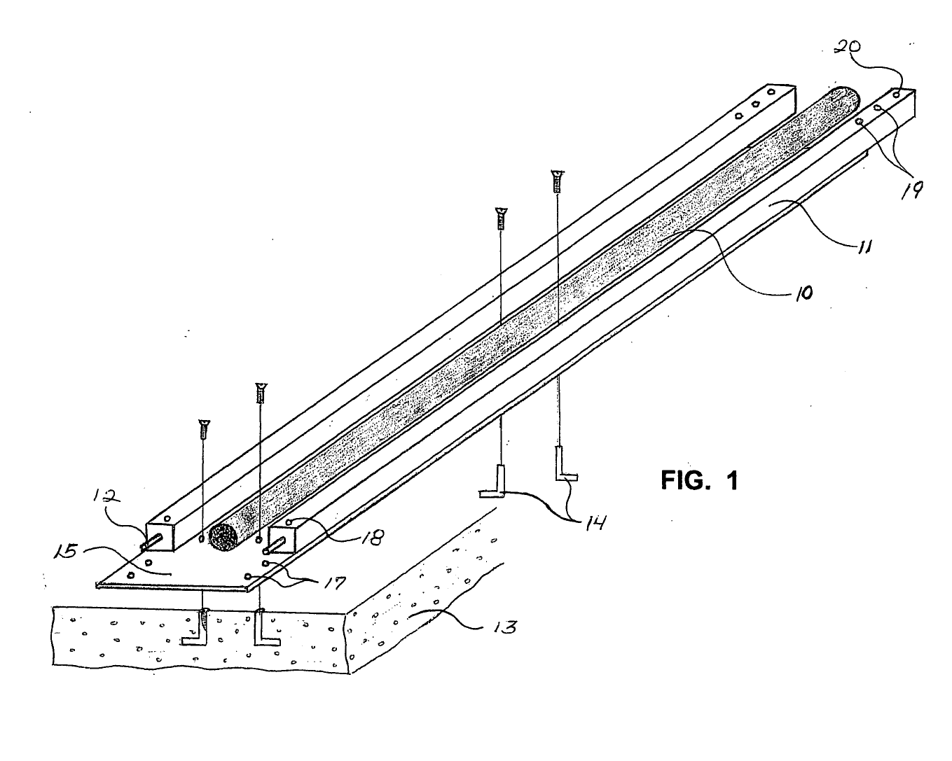

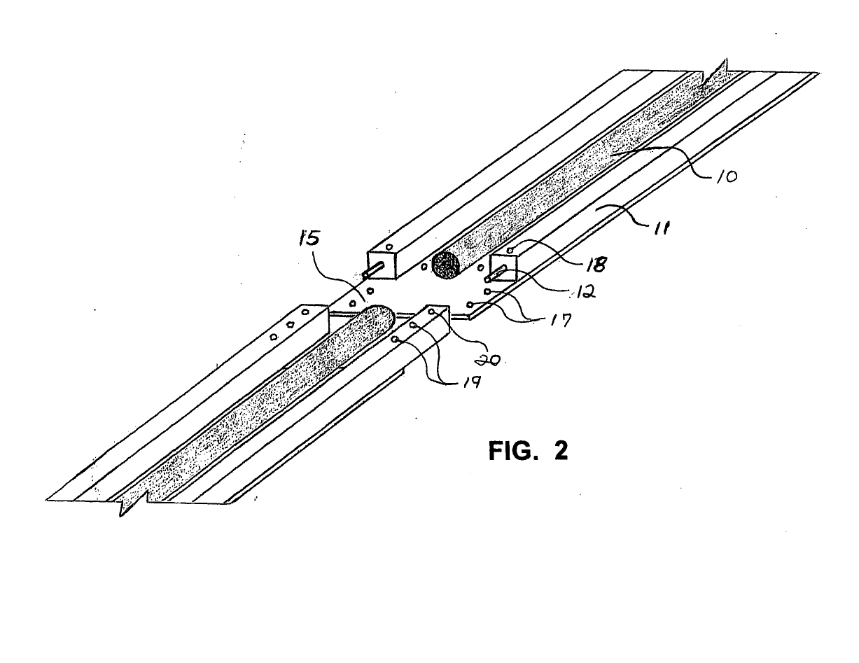

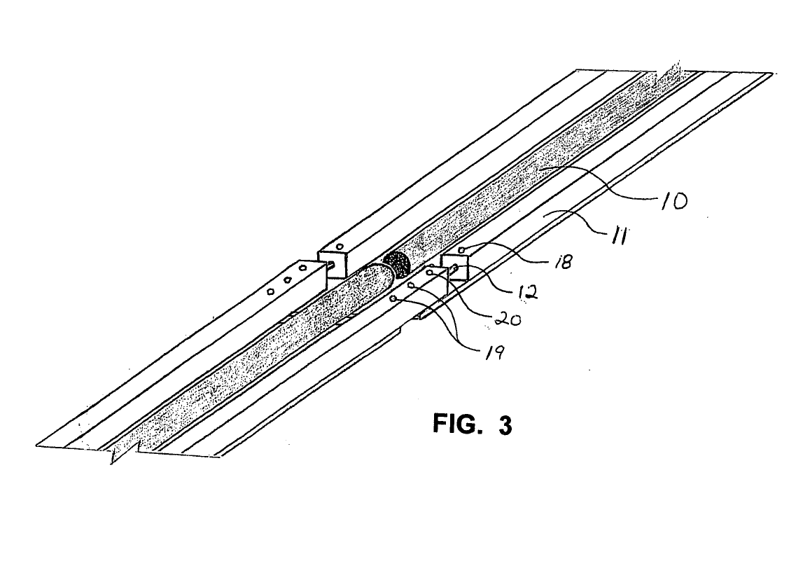

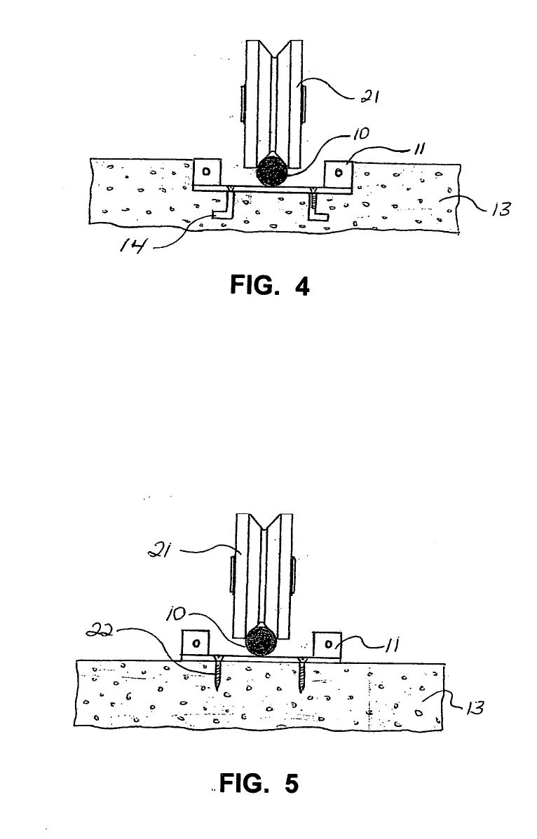

### DESCRIPTION OF THE REFERENCES NUMERALS

10. Stainless Steal Round Rod
11. Stainless Steal Square Rod
12. Fixed
13. Concrete
14. Anchorage to the Concrete
15. Stainless Steal Flat Bar
16. Grade Screws
17. Drilled holes to where the screws are inserted to assembled together the stainless steal square rod
18. Adjuster to the fixed on the male side of the stainless steal rod
19. Drilled holes through where the screw that attached the perforations is inserted 17
20. Adjuster to the fixed on the female side of the stainless steal square rod
21. Wheel
22. Screws that hold the stainless steal flat bar to the concrete with no anchorage

### DETAILED DESCRIPTION OF THE PREFERRED EMBODIMENT

This invention consists of a rail that requires minimum force to move an object that slides. It has a stainless steal round rod (10) that is secured to the stainless steal flat bar (15). The circumference of the stainless steal rod (10) from where the bar runs (21) will be determined based on the final use of the rail. The wheel (21) to be utilized will depends on the circumference of the stainless steal rod (10) and vice-versa. It also has two stainless steal rods (11) that assure the alignment once a second piece is added to the rail. To ensure the alignment, this stainless steal square rod (11) has a fixed (12) adjusted by a screw (20). Once these bars are assembled together they are attached to the stainless steal flat bar (15) with grade screws that will go in the bar through (19) and are fixed to the hole (17) of the stainless steal flat bar (15). The rail is anchored (14) to the concrete (13) with grade screws (16) or it can also be adhere to the concrete (13) with screws (22). The object will be placed over this rail and will be slide by one or a few wheels (21).

1. I claim a rail that requires minimum force to slide an object.

2. The system of claim 1, wherein can be assemble by said rail pieces until obtaining the desired length.

3. The system of claim 2, wherein the said rail use a round rod to smooth the sliding.
